(19) United States
(12) Patent Application Publication
(10) Pub. No.: US 2026/0244259 A1
(43) Pub. Date: Aug. 20, 2026

(54) MEASUREMENT SYSTEM AND HEAD-MOUNTED DISPLAY

(71) Applicant: MITSUBISHI ELECTRIC CORPORATION, Tokyo (JP)

(72) Inventors: Yoshitaka KAJIYAMA, Chiyoda ku, Tokyo (JP); Yasuhisa SHIMAKURA, Chiyoda ku, Tokyo (JP); Yoshiaki HIRATA, Chiyoda ku, Tokyo (JP)

(73) Assignee: MITSUBISHI ELECTRIC CORPORATION, Tokyo (JP)

(21) Appl. No.: 19/159,347

(22) PCT Filed: Mar. 24, 2023
(86) PCT No.: PCT/JP2023/011925

§ 371 Date: Aug. 25, 2025

(51) Int. Cl. G01S 15/32; G06F 3/01

(52) U.S. Cl. CPC G06F 3/011; G06F 3/017

(57) ABSTRACT

A measurement system includes: a first transmitter element to generate a first sound wave for transmission; a first receiver element to receive a second sound wave resulting from the first sound wave reflecting off an object; and a signal processing unit to: cause the first transmitter element to transmit the first sound wave and receive a first received signal corresponding to the second sound wave from the first receiver element. The signal processing unit is configured to calculate a distance to the object, based on a latest time at which an amplitude of the first received signal exceeds a determination value within a certain period of time since a time the first sound wave has been launched.

### TECHNICAL FIELD

The present disclosure relates to a measurement system and a head-mounted display.

### BACKGROUND ART

A ranging system that measures a distance by a time of flight (TOF) of a sound wave is already commercialized. A most simple ranging system is configured of a transmitter element and a receiver element, or of a transceiver element, which serves to transmitting and receiving sound waves, and a signal processing unit. The ranging system measures the distance to an object, based on a time the ranging system transmits a sound wave and a time the receiver element receives the sound wave reflected off the object.

By including two or more receiver elements, the ranging system may also be used as a position sensing system that senses not only the distance to an object but also the position of the object. Each receiver element can measure the position of the object in a two-dimensional or three-dimensional space, based on a difference in time they sense the reflected wave.

The ranging system is widely used for the vehicles and the like as an obstacle sensing system. The ranging system is, additionally, applied to gesture sensors. For example, the ranging system measures the distance to a hand and actions are assigned according to the distance, and wireless operations such as powering ON/OFF and volume tuning are thereby enabled.

An apparatus having such a ranging system applied thereto is disclosed in Japanese Patent Laying-Open No. 2005-266840. The apparatus uses a transmission means configured of an electromagnetic wave transmission circuit, an ultrasound transmission circuit, and a trigger transmission circuit. The apparatus determines three-dimensional space positional information from transmitting/receiving distance information obtained by using two transmission means having different speeds of propagation, positional information and distance information that are obtained by multiple receiving means. A cursor, displayed on a display device of a personal computer or the like, moves in conjunction with an operator moving the transmission means. Execution works such as clicking or dragging can also be implemented by providing the transmission means with multiple switches, which are trigger generating means.

### CITATION LIST

### Patent Literature

PTL 1: Japanese Patent Laying-Open No. 2005-266840

### SUMMARY OF INVENTION

### Technical Problem

In general, the ranging system calculates a distance, based on a signal that is initially received by the ranging system. Therefore, the distance that can be sensed by the ranging system is limited only to the distance to an object that is closest to a receiving sensor. Moreover, for a gesture sensor included in a head-mounted display (HMD) device, especially, having a goggle-like shape such as AR/VR goggles, reflected sound waves not only from a hand, but also from an arm are involved. Due to this, the distance to the hand cannot be accurately measured, making wireless operations by hand movements difficult.

The present disclosure is made to describe embodiments that solve problems like the above, and an object of the present disclosure is to provide a measurement system that measures the distance to an object of interest such as a hand when an object such as an arm is located closer to a sensor than the hand.

### Solution to Problem

The present disclosure relates to a measurement system. The measurement system includes: a first transmitter element to generate a first sound wave for transmission; a first receiver element to receive a second sound wave resulting from the first sound wave reflecting off an object; and a signal processing unit to: cause the first transmitter element to transmit the first sound wave; and receive a first received signal corresponding to the second sound wave from the first receiver element. The signal processing unit is configured to calculate a distance to the object, based on a latest time at which an amplitude of the first received signal exceeds a determination value within a certain period of time since a time at which the first sound wave has been launched.

### Advantageous Effects of Invention

According to the measurement system of the present disclosure, the distance to the object is calculated based on the latest time at which the amplitude of the first received signal is greater than the determination value in a certain period of time since the first sound wave has been launched. Due to this, the distance to an object such as a hand can be appropriately measured when an object to be non-detected, such as an arm, is closer to the sensor than the hand.

### BRIEF DESCRIPTION OF DRAWINGS

FIG. 1 is a diagram showing a configuration of a measurement system according to Embodiment 1.

FIG. 2 is a diagram for illustrating a sound wave transmitted by a transmitter element and received by a receiver element.

FIG. 3 is a diagram showing a transmission signal.

FIG. 4 is a diagram showing a received signal.

FIG. 5 is a diagram showing an example in which the measurement system according to Embodiment 1 is applied to an HMD.

FIG. 6 is a diagram showing a configuration of a measurement system according to Embodiment 2.

FIG. 7 is a layout diagram for illustrating determination of the position of an object in the measurement system according to Embodiment 2.

FIG. 8 is a waveform diagram for illustrating the determination of the position of the object in the measurement system according to Embodiment 2.

FIG. 9 is a diagram showing an example in which the measurement system according to Embodiment 2 is applied to an HMD.

FIG. 10 is a diagram showing a configuration of a measurement system according to Embodiment 3.

FIG. 11 is a diagram showing an example in which the measurement system according to Embodiment 3 is applied to an HMD.

FIG. 12 is a diagram showing a manner in which the measurement system according to Embodiment 3 is used to sense the positions of hands.

### DESCRIPTION OF EMBODIMENTS

Hereinafter, embodiments according to the present disclosure will be described, with reference to the accompanying drawings. In the following, a number of embodiments are described. The configurations described in respective embodiments are intended to be combined as appropriate in the application as initially filed. Note that the same reference signs are used to refer to the same or like parts, and the description thereof will not be repeated.

### Embodiment 1

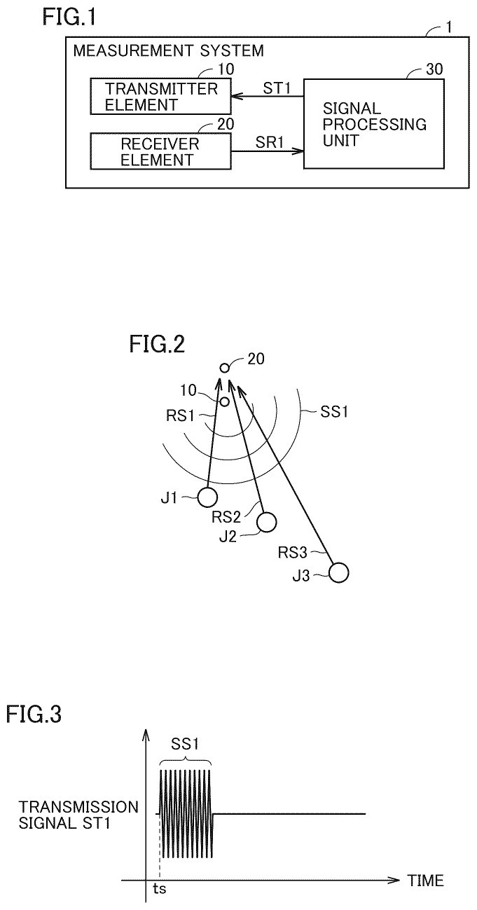

FIG. 1 is a diagram showing a configuration of a measurement system according to Embodiment 1. FIG. 2 is a diagram for illustrating a sound wave transmitted by a transmitter element and received by a receiver element.

Measurement system 1 shown in FIG. 1 includes a transmitter element 10, a receiver element 20, and a signal processing unit 30. As shown in FIG. 2, transmitter element 10 emits a transmission sound wave SS1. Receiver element 20 receives reflected sound waves RS1, RS2, and RS3 from objects J1, J2, and J3.

Signal processing unit 30 is configured to: generate a transmission signal for causing the transmitter element to transmit sound wave SS1; and process a received signal corresponding to a sound wave received by receiver element 20. One transceiver element, serving to transmitting and receiving sound waves, may be used as transmitter element 10 and receiver element 20.

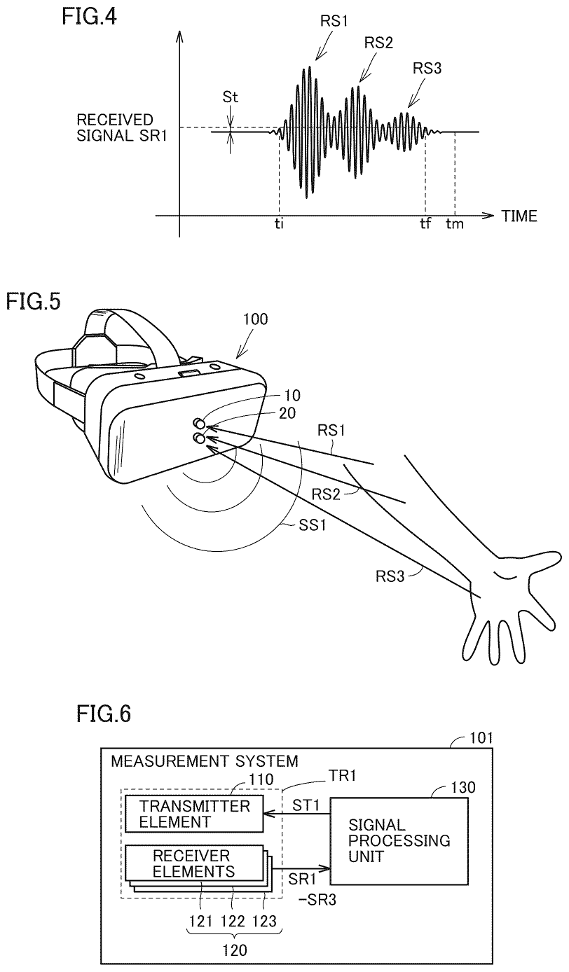

FIG. 3 is a diagram showing a transmission signal. FIG. 4 is a diagram showing a received signal. The transmission signal shown in FIG. 3 corresponds to sound wave. SS1, and time ts is a time to start the transmission of the transmission signal.

For example, a burst signal having a sine wave can be used as the transmission signal. While transmission time ts is the time to start the emission of the transmission signal in FIG. 3, transmission time ts may be the middle or end of the burst signal because the width of the transmission signal is sufficiently short relative to the width of the received signal. Various responses to these alternatives can be made by adjustment.

FIG. 4 shows received signals corresponding to sound waves RS1, RS2, and RS3 resulting from sound wave SS1 reflecting off objects J1, J2, and J3.

In common distance sensing, the distance to a closest object is calculated by TOF, based on the earliest time ti the amplitude of the signal exceeds a certain magnitude (a determination value St).

In the present embodiment, in contrast, distance d is calculated based on time tf. Time tf is the latest time at which the amplitude of the signal exceeds the certain magnitude (determination value St) in a certain period of time (from ts to tm) since the transmission time. For the calculation of distance d, for example, the following Equation (1) can be used:

$$d = ( tf - ts ) / 2 C \qquad ( 1 )$$

where d, ts, and C indicate a distance to the farthest object in a certain area, a transmission time, and a speed of sound, respectively. Within the certain area is within an area centered at the transceiver element and having a radius that is half the distance of travel of a sound from transmission time ts to time tm within the certain period of time. However, Equation (1) is one example mathematical formula, and correction may be made to Equation (1) due to delay in signal processing, for example.

As described above, in the present embodiment, the distance to the object is calculated, using time tf as a sound wave receive time. Time tf is the latest time at which the amplitude of the signal exceeds the certain magnitude (determination value St) within the certain period of time (from ts to tm) as shown in FIG. 4. This prevents sound waves RS1 and RS2 reflected off the closer objects J1 and J2 from affecting the distance detected by the measurement system.

Accordingly, the distance to the farthest object in an area within a certain distance originating from the measurement system can be measured.

FIG. 5 is a diagram showing an example in which the measurement system according to Embodiment 1 is applied to a HMD 100.

When the distance sensing system is mounted on the HMD, it is difficult, with a common method of sensing the distance or position of a closest object, to accurately sense the distance to a hand, due to reflection from an arm. For example, when the arm is stretched out while the HMD is being mounted, strong reflections off the arm appear as peaks of a sensed waveform as shown in FIG. 4. As a result, the position of a palm cannot be accurately sensed with the common method.

On HMD 100, a detection target, such as a hand of a user, is located in front of the screen viewed by the user. Stated differently, the screen and a transceiver unit of the sensor are present between the user's eyes and the detection target. Applying the scheme of sensing the distance to a farthest object in the certain area described in Embodiment 1 to the HMD in this arrangement enables sensing of the distance to a hand at a position that is farthest away from HMD 100. Within the certain area may be within an area within the radius of about 1 m from HMD 100, provided that the distance a human typically stretches out an arm is 1 m, for example. This enables operations of HMD 100 such as ON/OFF operation and volume tuning, for example, according to changes in distance to the hand.

For example, if objects J1 and J2 are associated with the arm and object J3 is associated with the hand, the distance to the hand can be measured, without being affected by the arm, by calculating the distances to the objects, using time tf as the sound wave receive time. Time tf is the latest time at which the amplitude of the signal exceeds the certain magnitude (determination value St) in the waveform of FIG. 4.

### Embodiment 2

In Embodiment 2, two or more receiver elements are disposed in the measurement system according to Embodiment 1 to detect the position of a farthest object in a certain area, based on a difference in reflected sound wave receive time between the respective receiver elements.

FIG. 6 is a diagram showing a configuration of a measurement system according to Embodiment 2. A measurement system 101 shown in FIG. 6 includes a first transmitter element 110 which generates a first sound wave SS1 for transmission, a first receiver element 121 which receives second sound waves RS1 to RS3 resulting from first sound wave SS1 reflecting off an object, and a signal processing unit 130 which causes first transmitter element 10 to transmit a first sound wave SS1 and receives a first received signal SR1 corresponding to second sound waves RS1 to RS3 from first receiver element 121. The above configuration is the same as Embodiment 1.

Measurement system 101 shown in FIG. 6 further includes a second receiver element 122 which is disposed at a position different from first receiver element 121 and receives the second sound waves. Signal processing unit 130 receives a second received signal SR2 corresponding to the second sound wave from second receiver element 122 and detects the position of an object, based on first received signal SR1 and second received signal SR2.

While a two-dimensional position can be determined with the above components, measurement system 101 shown in FIG. 6 further includes a third receiver element 123 which is disposed at a position different from first receiver element 121 and second receiver element 122 and receives the second sound waves. Signal processing unit 130 receives a third received signal SR3 corresponding to the second sound wave from third receiver element 123 and detects the position of an object, based on first received signal SR1, second received signal SR2, and third received signal SR3. This enables determination of a three-dimensional position.

In the above configuration, a position sensing unit TR1 transmits/receives signals ST1 and SR1 to SR3 to/from signal processing unit 130. Position sensing unit TR1 includes a transmitter element 110 and a receiver unit 120. Receiver unit 120 includes receiver elements 121, 122, and 123.

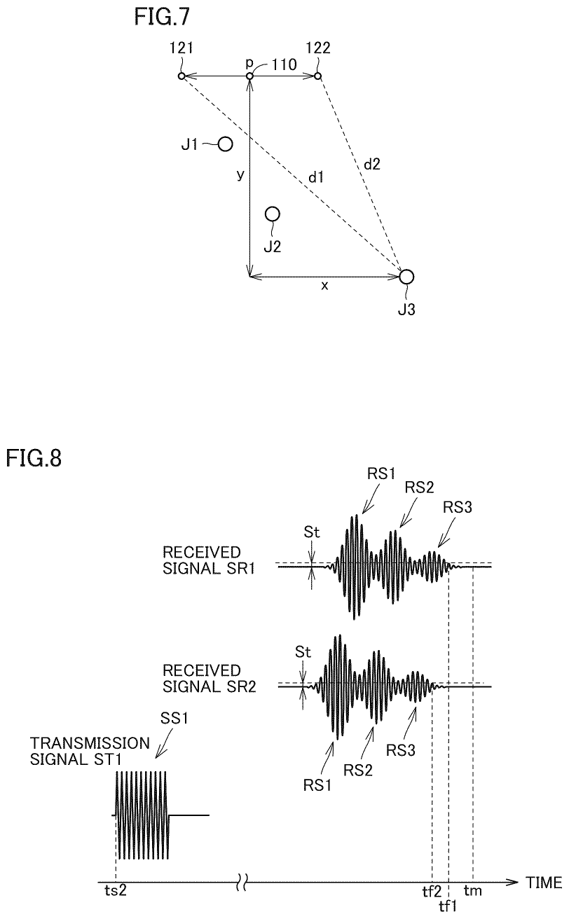

FIG. 7 is a layout diagram for illustrating determination of the position of an object in the measurement system according to Embodiment 2. FIG. 8 is a waveform diagram for illustrating the determination of the position of the object in the measurement system according to Embodiment 2. For ease of explanation, determination of a two-dimensional position, using two receiver element 121 and 122, will be described, with reference to FIGS. 7 and 8.

In the case of the arrangement as shown in FIG. 7, if the distance between receiver element 121 and receiver element 122 is sufficiently short relative to the distance to the object, the farthest object detected by receiver element 121 and the farthest object detected by receiver element 122 is the same object J3. Thus, the position (x, y) of object J3 can be determined from distances d1 and d2.

As shown in FIGS. 7 and 8, signal processing unit 130 is configured to calculate distance d1 to object J3, based on time tf1. Time tf1 is the latest time at which the amplitude of first received signal SR1 exceeds a determination value St in a certain period of time tm since a time ts2 the first sound wave SS1 has been launched.

Furthermore, signal processing unit 130 is configured to calculate distance d2 to object J3, based on time tf2. Time tf2 is the latest time at which the amplitude of second received signal SR2 exceeds determination value St in the certain period of time tm since time ts2 the first sound wave SS1 has been launched.

The principle of the positional determination is now described. FIGS. 6 and 7 are used to show an example of calculation of the position of a farthest object in a certain area when two receiver elements are disposed. Using the same method as Embodiment 1, distances d1 and d2 from receiver element 121 and 122, respectively, to the farthest object in the certain area are calculated by the following Equations (2) and (3):

$$d 1 = ( tf 1 - ts ) / 2 C \qquad ( 2 )$$

$$d 2 = ( tf 2 - ts ) / 2 C \qquad ( 3 )$$

A circle having a radius d1 centered at receiver element 121 and a circle having a radius d2 centered at receiver element 122 intersect at a point on a plane when limited to the front side, which allows the determination of a position (x, y) of the farthest object in the certain area in the two-dimensional space.

If three elements are disposed, the position can be sensed in a three-dimensional space. Similarly, time tf3 and a detection distance d3 corresponding to receiver element 123 can be calculated by the following Equation (4):

$$d 3 = ( tf 3 - ts ) / 2 C \qquad ( 4 )$$

In the three-dimensional space, a sphere having radius d1 centered at receiver element 121, a sphere having radius d2 centered at receiver element 122, and a sphere having a radius d3 centered at receiver element 123 intersect at a point in the three-dimensional space when limited to the front side, which allows the determination of a position (x, y, z) of the farthest object in the certain area in a three-dimensional space.

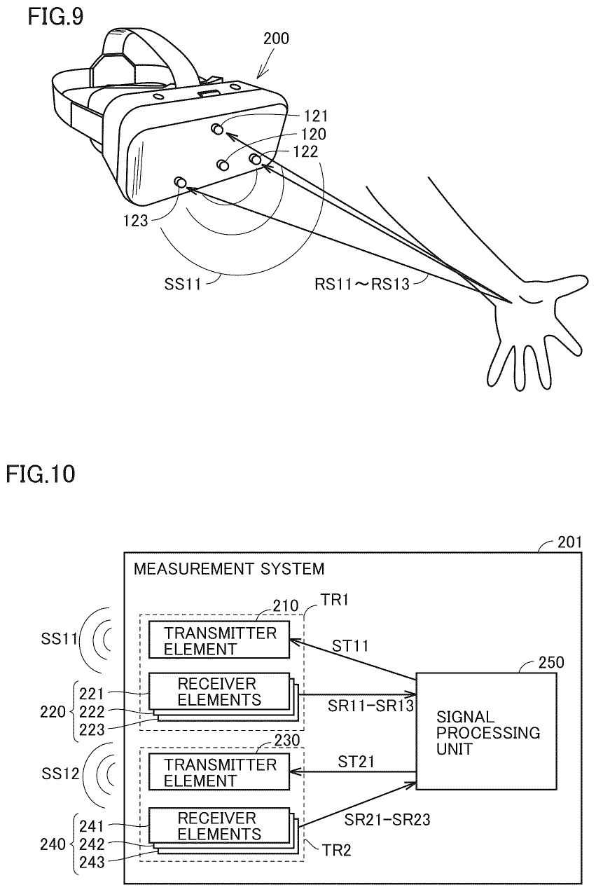

FIG. 9 is a diagram showing an example in which the measurement system according to Embodiment 2 is applied to an HMD 200. When the position sensing system is mounted on the HMD, with a common method for sensing the distance or position of a closest object, it is difficult to accurately sense the position of a hand due to the reflection from an arm.

On the HMD, a detection target, such as a hand, is located in front of the screen viewed by a user. Stated differently, the screen and a transceiver unit of a sensor are located between the user's eyes and the detection target. In the present embodiment, applying the scheme of sensing the position of a farthest object in a certain area, as described in Embodiment 1, to the HMD in this arrangement enables sensing of the position of a hand that is farthest away from an HMD 100. Within the certain area may be within an area within the radius of about 1 m from HMD 200, provided that the distance a human typically stretches out an arm is 1 m, for example. This enables operations such as changing the position of the pointer displayed on the display of the HMD and a screen swipe, for example, according to changes in position of the hand.

For example, if objects J1 and J2 are associated with the arm and object J3 is associated with the hand, distance d1 to the hand can be measured, without being affected by the arm, by calculating the distances to the objects, using time tf1 as the sound wave receive time. Time tf1 is the latest at which the amplitude of the signal exceeds the certain magnitude (determination value St) in the waveform of received signal SR1 of FIG. 8.

Similarly, distance d2 to a hand can be measured, without being affected by the arm, by calculating the distances to the objects, using time tf2 as the sound wave receive time. Time tf2 is the latest time at which the amplitude of the signal exceeds the certain magnitude (determination value St) in the waveform of received signal SR2 of FIG. 8.

Although not shown, distance d3 to the hand can be measured, without being affected by the arm, by calculating the distances to the objects, using time tf3 as the sound wave receive time. Time tf3 is the latest time at which the amplitude of the signal exceeds the certain magnitude (determination value St) in the waveform of received signal SR2.

The determination of distances d1, d2, and d3 allows determination of the position of the hand.

### Embodiment 3

In Embodiment 3, two or more position sensing units are disposed in the measurement system according to Embodiment 2 to detect the position of a farthest object in a first region and the position of a farthest object in a second region from a difference in reflected sound wave receive time between the respective receiver elements.

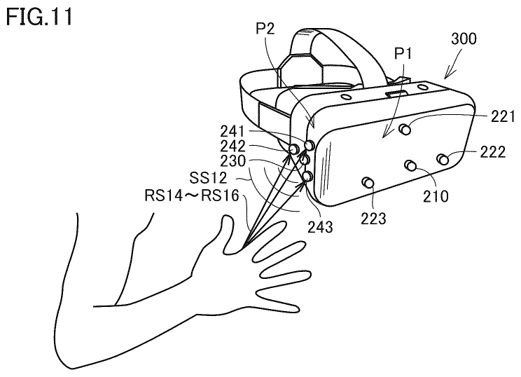

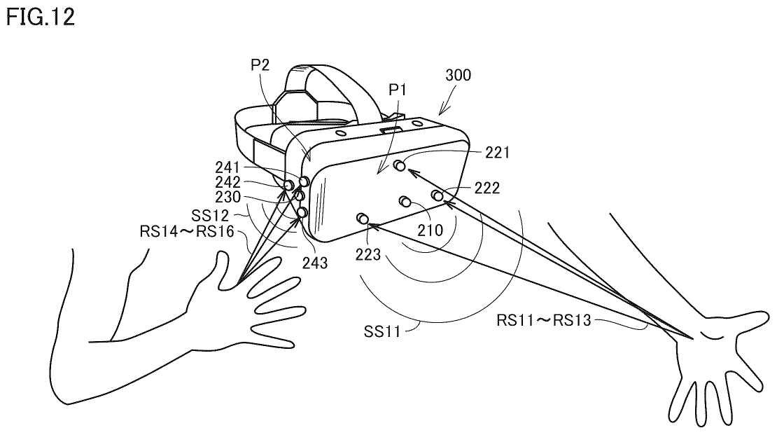

FIG. 10 is a diagram showing a configuration of a measurement system according to Embodiment 3. FIG. 11 is a diagram showing an example in which the measurement system according to Embodiment 3 is applied to an HMD. FIG. 12 is a diagram showing a manner in which the measurement system according to Embodiment 3 is used to sense the positions of hands.

A measurement system 201 shown in FIG. 10 includes a position sensing unit TR1, a position sensing unit TR2, and a signal processing unit 250.

Position sensing unit TR1 includes a transmitter element 210 which generates a sound wave SS11 for transmission, and a receiver unit 220 for receiving sound waves RS11, RS12, and RS13 resulting from a sound wave SS11 reflecting off an object. Receiver unit 220 includes a receiver element 221, a receiver element 222, and a receiver element 223.

Signal processing unit 250 causes transmitter element 210 to transmit sound wave SS11, receives a received signal SR11 corresponding to sound waves RS11 to RS13 from receiver element 221, receives a received signal SR12 corresponding to second sound waves RS1, RS2, and RS3 from receiver element 222, and receives a received signal SR13 corresponding to sound waves RS1 to RS3 from receiver element 223.

The above configuration is the same as Embodiment 3. In addition, measurement system 201 receives received signals SR21, SR22, and SR23 from position sensing unit TR2.

Position sensing unit TR2 includes a transmitter element 230 which generates a sound wave SS12 for transmission, and a receiver unit 240 for receiving sound waves RS14, RS15, and RS16 resulting from sound wave SS12 reflecting off an object. Receiver unit 240 includes a receiver element 241, a receiver element 242, and a receiver element 243.

Signal processing unit 250 causes transmitter element 230 to transmit sound wave SS12, receives received signal SR21 corresponding to sound waves RS14 to RS16 from receiver element 241, receives received signal SR22 corresponding to RS14 to RS16 from receiver element 242, and receives received signal SR23 corresponding to RS14 to RS16 from receiver element 243.

The above configuration enables determination of a position of an object in each of two three-dimensional areas.

In an HMD 300, for example, two different positions P1 and P2 are shown as in front of the display (a position P1) and on a side of the display (a position P2). First position sensing unit TR1 is disposed at position P1, and second position sensing unit TR2 is disposed at position P2.

Since the transmitter element and the receiver elements are on the side of the HMD in this manner, the position of a hand in the lateral direction of the HMD can also be sensed. This enables sensing of the position of a hand in an extended range.

### (Variation 1)

In Embodiment 3, in the configuration in which the transceiver units are disposed each in front of the HMD (position P1) and on the side of the HMD (position P2), the sound wave transmitted by transmitter element 210 disposed in front of the HMD and the sound wave transmitted by transmitter element 230 disposed on the side of the HMD have different frequencies.

If the frequencies are the same, the reflected waves from the hands are detected by the receiver elements both in front and on the side of the HMD. This causes inaccurate measurement results. By setting the frequencies of the transmitter elements in front and on the side of the HMD to different values, a band-pass filter or the like can be used to separately set frequencies to be detected, among those of the sound waves received by the receiver elements. Accordingly, even if the hands come close to the front and on the side of the HMD simultaneously, the positions of the hands can be sensed independently of each other.

For two transmitter elements whose frequencies are apart from each other by, for example, about 20 kHz, 50 KHz and 70 kHz (additionally, 90 kHz for three elements) are available. How far apart the values of the frequencies of the transmitter elements defined are from each other needs to be modified, depending on element characteristics, primarily, Q values. At this time, the values need to be defined so that the frequency of a sound wave used by one transmitter element is sufficiently apart from the frequency of a resonance frequency of the other transmitter element.

### (Variation 2)

In Embodiment 3, in the configuration in which the transceiver units are each disposed in front of the HMD (position P1) and on the side of the HMD (position P2), even if the sound wave transmitted by transmitter element 210 disposed in front of the HMD and the sound wave transmitted by transmitter element 230 disposed on the side of the HMD have the same frequency, similar detection is enabled by staggering the transmission timings by transmitter element 210 and transmitter element 230 from each other.

For example, even if the frequencies are the same, the transmission and reception by transmitter element 210 and receiver elements 221 to 223 included in position sensing unit TR1 and the transmission and reception by transmitter element 210 and receiver elements 221 to 223 included in position sensing unit TR1 may be alternately used. In that case, however, the frame rate decreases by more than half.

### Embodiment 4

In the HMD according to Embodiment 3 in which the position sensing units TR1 and TR2 are disposed in front of the HMD and on the side of the HMD, respectively, a positional control is performed on the pointer on the screen by the position of a hand sensed in front of the HMD, and an action control is performed on the pointer on the screen by the position of another hand sensed on a side of the HMD. Note that the positional control may be performed on the pointer on the screen by the position of a hand sensed on a side of the HMD, and the action control may be performed on the pointer on the screen by the position of another hand sensed in front of the HMD.

The action such as selection or dragging is a common action that is performed with a mouse. The action is assigned in correspondence with a hand movement such as a hand moving to be closer to the HMD and then moving away from the HMD or a hand moving in a circular motion. This enables a more complex control over the HMD by hand movements.

In general, the pointer position and action of the HMD are implemented by mounting an inertial sensor or the like on a hand, or a button held in a hand being depressed. In the present embodiment, however, the sensor may not be mounted on a hand.

### CONCLUSION

In the following, the embodiments according to the present disclosure will be summarized, with reference to the accompanied drawings again.
(1) The present disclosure relates to a measurement system. Measurement system 1 shown in FIG. 1 includes first transmitter element 10 to generate first sound wave SS1 for transmission; the first receiver element 20 to receive second sound waves RS1 to RS3 resulting from first sound wave SS1 reflecting off an object; signal processing unit 30 to: cause first transmitter element 10 to transmit first sound wave SS1; and receive first received signal SR1 corresponding to second sound waves RS1 to RS3 from the first receiver element 20. As shown in FIGS. 3 and 4, signal processing unit 30 is configured to calculate a distance to the object, based on time tf. Time tf is the latest time at which an amplitude of first received signal SR1 exceeds determination value St within the certain period of time tm since time ts at which the first sound wave SS1 has been launched,
(2) The measurement system according to Clause 1 further includes second receiver element 122 to receive the second sound wave, the second receiver element 122 being disposed at a position different from first receiver element 121, as measurement system 101 shown in FIGS. 6 and 9. Signal processing unit 130 receives second received signal SR2 corresponding to the second sound wave from second receiver element 122 and detects a position of the object based on first received signal SR1 and second received signal SR2.
(3) The measurement system according to Clause 2, as measurement system 201 shown in FIGS. 10 and 11, further includes second transmitter element 230, third receiver element 241, and fourth receiver element 242, in addition to first transmitter element 210 to generate first sound wave SS1 for transmission, first receiver element 221 to receive second sound waves RS1 to RS3 resulting from first sound wave SS1 reflecting off the object, and second receiver element 222. Second transmitter element 230 generates third sound wave SS12 for transmission, the second transmitter element 230 being disposed at a position different from first transmitter element 210. Third receiver element 241 receives the fourth sound wave resulting from third sound wave SS12 reflecting off the object, the third receiver element 241 being disposed at a position different from first receiver element 221 and second receiver element 222. Fourth receiver element 242 receives the third sound wave, the fourth receiver element 242 being disposed at a position different from first receiver element 221, second receiver element 222, and third receiver element 241. Signal processing unit 250 causes second transmitter element 230 to transmit third sound wave SS12, receives third received signal SR21 corresponding to the fourth sound wave from third receiver element 241, and receives fourth received signal SR22 corresponding to the fourth sound wave from fourth receiver element 242. Signal processing unit 250 is configured to detect the position of the object based on the first to fourth received signals SR11, SR12, SR21, and SR22.
(4) In the measurement system according to Clause 3, first sound wave SS11 and third sound wave SS12 have different frequencies.
(5) In the measurement system according to Clause 3, a time of transmission of first sound wave SS11 and a time of transmission of third sound wave SS12 (launch time, emission time) are different.
(6) In the measurement system according to Clause 3, first transmitter element 210, first receiver element 221, and second receiver element 222 constitute first position sensing unit TR1, and second transmitter element 230, third receiver element 241, and fourth receiver element 242 constitute second position sensing unit TR2, as shown in FIGS. 10 and 12. The object includes both hands, and signal processing unit 250 is configured to recognize a position of a first hand sensed by first position sensing unit TR1, among the both hands, as a position of a pointer, and recognize a position of a second hand sensed by second position sensing unit TR2, among the both hands, as a position indicating an action.
(7) In another aspect, the present disclosure relates to a head-mounted display including the measurement system according to any one of Clauses 1 to 6.

The presently disclosed embodiments should be considered in all aspects as illustrative and not restrictive. The scope of the present disclosure is defined by the appended claims, rather than by the description of the embodiments above. All. changes which come within the meaning and range of equivalency of the appended claims are to be embraced within their scope.

### REFERENCE SIGNS LIST

101, 201 measurement system; 2, 10, 110, 210, 230 transmitter element; 20, 121 to 123, 221 to 223, 241 to 243 receiver element; 30, 130, 250 signal processing unit; 120, 220, 240 receiver unit; J1, J2, J3 object; and TR1, TR2 position sensing unit.

1. A measurement system, comprising:
a first transmitter element to generate a first sound wave for transmission;
a first receiver element to receive a second sound wave resulting from the first sound wave reflecting off an object; and
a signal processing unit to: cause the first transmitter element to transmit the first sound wave; and receive a first received signal corresponding to the second sound wave from the first receiver element, wherein
among the second sound waves in which the amplitude of the first received signal exceeds the determination value, the signal processing unit is configured to calculate a distance to the object based on a reception time of sound wave received at a latest time from a time at which the first sound wave has been launched.

2. The measurement system according to claim 1, further comprising
a second receiver element to receive the second sound wave, the second receiver element being disposed at a position different from the first receiver element, wherein
the signal processing unit is configured to receive a second received signal corresponding to the second sound wave from the second receiver element and detect a position of the object based on the first received signal and the second received signal.

3. The measurement system according to claim 2, further comprising:
a second transmitter element to generate a third sound wave for transmission, the second transmitter element being disposed at a position different from the first transmitter element;
a third receiver element to receive a fourth sound wave resulting from the third sound wave reflecting off the object, the third receiver element being disposed at a position different from the first receiver element and the second receiver element;
a fourth receiver element to receive the third sound wave, the fourth receiver element being disposed at a position different from the first receiver element, the second receiver element, and the third receiver element, wherein
the signal processing unit is configured to cause the second transmitter element to transmit the third sound wave; receive a third received signal corresponding to the fourth sound wave from the third receiver element; and receive a fourth received signal corresponding to the fourth sound wave from the fourth receiver element, and
the signal processing unit is configured to detect the position of the object, based on the first received signal, the second received signal, the third received signal, and the fourth received signal.

4. The measurement system according to claim 3, wherein
the first sound wave and the third sound wave have different frequencies.

5. The measurement system according to claim 3, wherein
a time of transmission of the first sound wave and a time of transmission of the third sound wave are different.

6. The measurement system according to claim 3, wherein
the first transmitter element, the first receiver element, and the second receiver element constitute a first position sensing unit,
the second transmitter element, the third receiver element, and the fourth receiver element constitute a second position sensing unit,
the object includes a first hand and a second hand of both hands, and
the signal processing unit is configured to recognize a position of the first hand sensed by the first position sensing unit, as a position of a pointer, and recognize a position of the second hand sensed by the second position sensing unit, as a position indicating an action.

7. A head-mounted display comprising
the measurement system according to claim 1.

8. The measurement system according to claim 1, wherein
the signal processing unit has a maximum ranging time determined in advance from a maximum distance to the object,
the signal processing unit is configured to calculate the distance to the object based on the latest time at which the amplitude of the first received signal exceeds the determination value within the maximum ranging time from the time at which the first sound wave has been launched.
